(19) United States
(12) Patent Application Publication
(10) Pub. No.: US 2015/0150752 A1
(43) Pub. Date: Jun. 4, 2015

(54) Sex Toy

(71) Applicant: Benjamin Sierra Bernstein, Spencerville, MD (US)

(72) Inventor: Benjamin Sierra Bernstein, Spencerville, MD (US)

(21) Appl. No.: 14/053,958

(22) Filed: Dec. 3, 2013

(51) Int. Cl. A61H 19/00

(52) U.S. Cl. CPC A61H 19/44

(57) ABSTRACT

One embodiment of a sex toy for simulating a sexual encounter by a user having a base unit being substantially hour glass shape comprising a configuration of members for engagement by a user's feet. The body assembly is an elongated tubular member and is mated to the front end of the base unit. A support arm having a stimulating element attached to its distal end is attached to the body assembly. A pair of elongated tubular members each comprising a strapping mechanism are also for engagement of the user's feet and are threaded to the right and left sides of the base unit. In use, a user gets into the desired position with the apparatus between the user's legs. After insertion of the stimulating element, the user manipulates the apparatus by use of hands or feet or both hands and feet together.

### BACKGROUND

### Prior Art

The following is a tabulation of some prior art that presently appears relevant:

### U.S. Patents

| Patent Number | Kind Code | Issue Date | Patentee |
|---|---|---|---|
| 6,540,667 | B2 | 2003 Apr. 1 | Kenneth L. Hickman |
| 6,179,795 | B1 | 2001 Jan. 30 | Ronaldo Arturo Garza |
| 8,313,424 | B2 | 2012 Nov. 20 | Pericles Gabrielidis |
| 7,513,868 | B1 | 2009 Apr. 7 | Tony Fontenot |
| 6,991,599 | B2 | 2006 Jan. 31 | Donald E. Hudson |
| 6,899,671 | B1 | 2005 May 31 | Tony Fontenot |
| 6,926,006 | | 2005 Aug. 9 | Lester Lonnie |
| 7,246,781 | | 2007 Jul. 24 | Simon Sui Man |

### U.S. Pending Applications

| | | | |
|---|---|---|---|
| 20060264700 | A1 | (File Date) 2006 May 23 | Buddy Guy |

It is well known in the art that throughout history women and men have used various types of apparatus for masturbation. A hand held phallic device such as a dildo for vaginal and/or anal penetration for women and for anal penetration for men is commonly used as means for a man or woman to simulate a sexual experience.

Because of the limitations of these types of hand held devices, various other devices have been built in an attempt to relieve the user of having to hold the dildo by hand. Without having to hold the dildo by hand, a user can more closely feel like he or she is having an actual sexual experience with a partner.

Alleviating the need for the user to have to hold the phallic device by hand is only part of the solution towards simulating an actual sexual experience with a partner.

The ability to be able to move into various positions, and to be able to move into these positions easily while using a dildo or other masturbation device will allow a user to more closely feel that they are having an actual sexual experience with a partner during his masturbation session.

For example, the user may prefer to lie on a flat surface in a supine position while starting his or her session and after a while wish to move so that he or she is laying on her side or on her knees or even standing up. Additionally, while in these positions the user may want to be able to control the spread of his or her feet and legs. For example, a user may want to have his feet spread outwards and keep his knees relatively close together or vice versa, or, the user may want to have her feet and knees spread outwards simultaneously. The ability for the user to be able to control the position of his or her hips and legs are also factors that allow a more real sexual simulation. For example, it is desirable to a user to have the ability to control whether his or her legs are fully extended or bent towards her upper torso so that her knees are close to her chest. Additionally a user may want to be able to use only the hips for thrusting and movement while being able have his or her hands at the sides of her body or above her head.

Ease of use is also a need that a user has for selection of his or her device. If a device requires difficult assembly before each use and difficult disassembly afterwards, a user will be less enthusiastic about starting a session. Many users also prefer to be able to store their devices so that they are not seen in the common areas of their homes so a device that takes up minimal storage space is most preferable.

There has been a need for devices for use in masturbation and several have been patented to fill this need. For example, U.S. Pat. No. 6,899,671 issued 13 May 2005 to Tony Fontenot relates to an intra-vaginal stimulation apparatus. U.S. Pat. No. 6,179,795 issued 30 Jan. 2001 Ronaldo Arturo Garza is an adult novelty device. U.S. Pat. No. 6,991,599 issued 31 Jan. 2006 to Donald E. Hudson describes a personal exercise system. U.S. Pat. No. 7,513,868 issued 7 Apr. 2009 is a stimulation aid. U.S. Pat. No. 8,313,424 issued 20 Nov. 2012 to Pericles Gabrielidis describes a sex toy. U.S. Pat. No. 6,540,667 issued 30 Jul. 2001 describes a marital aid. U.S. Pat. No. 7,246,781 issued 2007 Jul. 24 to Simon Sui Man is a swivel stand with a suction base for a phallic device. Finally, U.S. Pat. No. 6,926,006 issued to Lester Lonnie in 2005 Aug. 9 is a bench with a swing seat used for sexual stimulation.

While these devices fulfill a users need to masturbate with certain levels of satisfaction, they fall short being a device fulfilling the need that will allow a user to simulate an actual sexual experience with a real partner. All but one requires the users to use their hands to manipulate the device while using it for the intended purpose. None allows users a large variety of positions.

If one searches the internet for “sex machines” or “fucking machines” a wide variety of devices are found that employ mechanisms for moving a mounted dildo or other stimulation member in a reciprocating motion meant to simulate the motions of intercourse between two partners. While there may be a market for these types of devices, their role in simulating a real sexual experience is limited by several factors. The cost of the devices is very high. The size and weight of the devices makes them difficult to move easily by one person and difficult to store and limits their ability to be used in the various natural positions of intercourse.

Therefore there is currently a need for a single masturbation device that allows the use of hands alone, of feet and legs alone, or hands and legs together, allows for a large variety of sexual positions, allows for comfortable body movement, is easy to assemble and disassemble and is compact enough to store for privacy. Those familiar with the art will therefore see that the present invention resolves the shortcomings of the prior art and fulfills the need that currently exists in the field.

### SUMMARY

In accordance with one embodiment of the invention, there is a base unit, an elongated tubular member (a body assembly) attached to the base unit and a support arm attached to the body assembly having means on one end to securely receive a stimulating element such as a dildo. The base unit comprises a configuration of members allowing a user to place both feet onto the base unit in a manner that allows the user to manipulate movement of the embodiment while gripping the base unit with the user's feet. It is also designed for easy engagement and disengagement of the user's feet from the base unit. A pair of elongated tubular members with a strapping mechanism is also attached perpendicularly to the base unit for manipulating the device by the user's feet and legs. A support arm is clamped at a desired location on any part of the body assembly. A dildo or other stimulating element is mounted to a receptacle on the opposite end of the of support arm.

A user, with the sex toy gets into the desired position either laying on his or her back, side, on hands and knees, standing up or standing bent over an appropriate piece of furniture. From one of the starting positions with the user on his or her back on a flat surface, and by placing his or her feet into the straps of the large foot rests, or by placing his or her feet onto the foot placement sections on the base unit, can insert the stimulating element into an orifice by pulling the device towards an orifice by raising his knees towards his chest. Alternately, the user can use her hands alone to grab the body of the device and manipulate the stimulating element as desired. If the user is standing up, the stimulating element can be inserted by pulling up on the body assembly by using the hands or the user can squat at the knees and move in an up and down motion to move the dildo in and out of an orifice.

### Advantages

Accordingly, several advantages of one or more aspects are as follows: to provide a device that can be easily assembled and disassembled, that can be stored easily, that is relatively inexpensive, that can be used in a hands free manor, that can be used with hands alone, that can be used with hands and feet together, that can quickly change the position of the support arm, that can allow the user many varying positions, that will allow the user have precise control of speed and intensity of longitudinal movement, to allow the user to have precise control of transverse movement of the device.

### FIGURES

FIG. 1 shows a perspective view of an embodiment when disassembled

FIG. 1A show an embodiment without the large footrests

FIG. 1B shows a close up perspective view of the base unit

FIG. 2 shows a perspective view of an embodiment when assembled

FIGS. 3-7 show a female user lying on her back on a flat surface using an embodiment in various positions

FIGS. 8-9 show a female user on her hands and knees using an embodiment

FIGS. 10-11 show a female user on her side using an embodiment with the large footrests unattached

FIG. 12 shows the an embodiment of the invention showing the multiple possible positions of the support arm

FIG. 13A shows a side view of the support arm in detail

FIG. 13B shows a rear view of the support arm with the clamp in the closed position

FIG. 13C shows a rear view of the support arm with the clamp in the closed position

FIG. 14 shows a perspective view of an embodiment from a side position

FIGS. 15-18 show 2 additional positions when using the embodiment

FIGS. 19-23 show alternate embodiments of the device

### REFERENCE NUMERALS

100 Disassembled embodiment
200 assembled embodiment
300 alternate embodiment
400 alternate embodiment
500 alternate embodiment
600 alternate embodiment
700 alternate embodiment
800 alternate embodiment
12 base unit
16L large footrest female thread
16R large footrest female thread
18 foot placement section
19 slide fin
20L large left footrest
20R large right footrest
22L left foot strap
22R right foot strap
24L large left footrest male thread
24R large right footrest male thread
26 lower body receptor
26A button catch hole
28A lower body socket lock
28B upper body receptor
28 lower body
30 Ridges
32A Upper body socket lock
32 Upper body
33 body assembly
40 support arm
41 latch handle
42 hinge
43 securing bar
44 clamp
44A recessed grooves
45 securing groove
46 latch base
38 Element mount
50 Stimulating element
60 female user
70 flat surface

### DETAILED DESCRIPTION OF AN EMBODIMENT AS SHOWN IN THE DRAWINGS

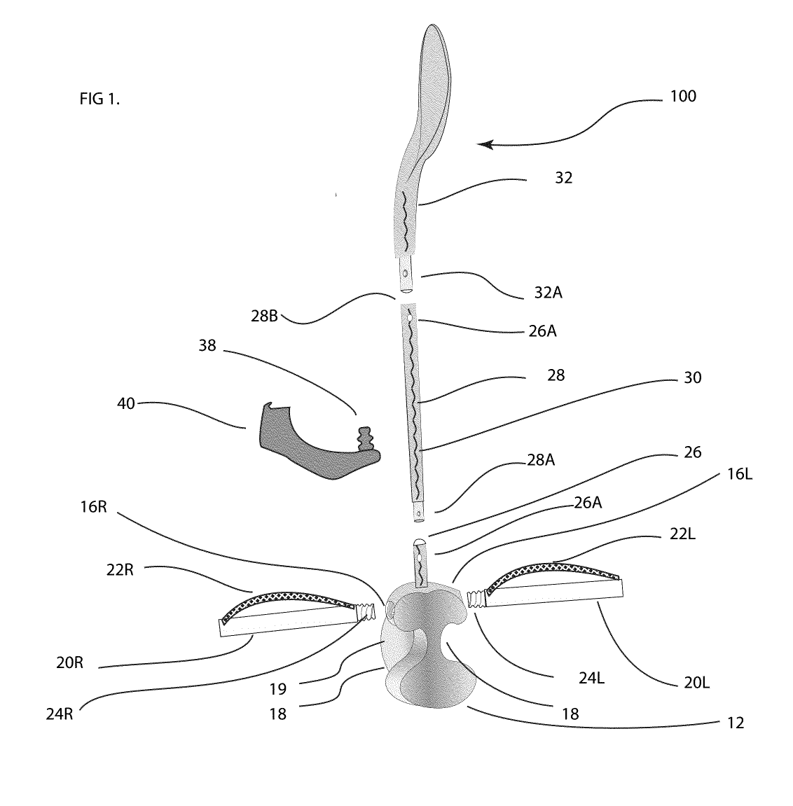

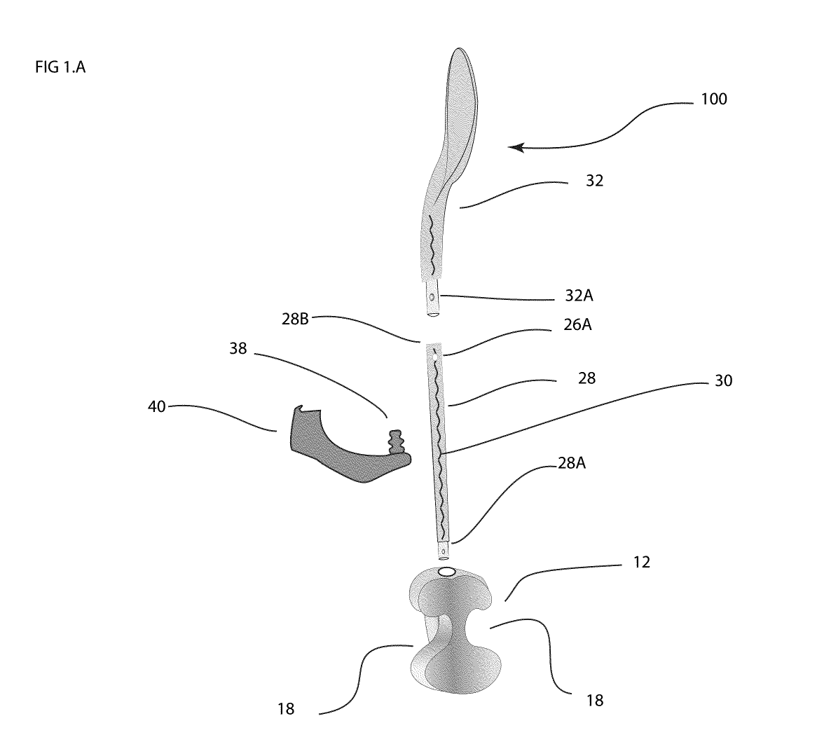

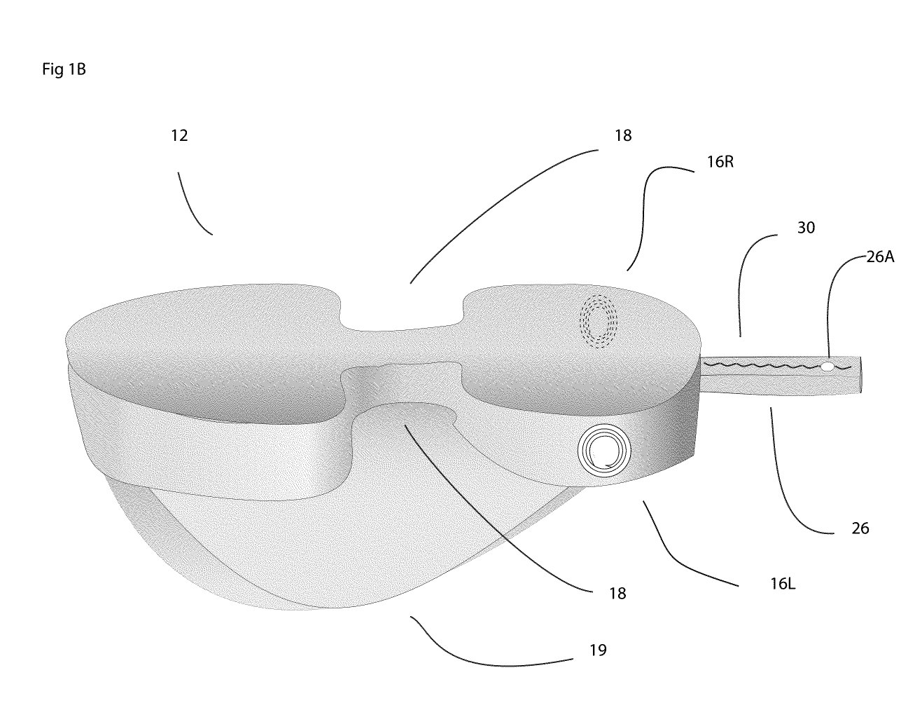

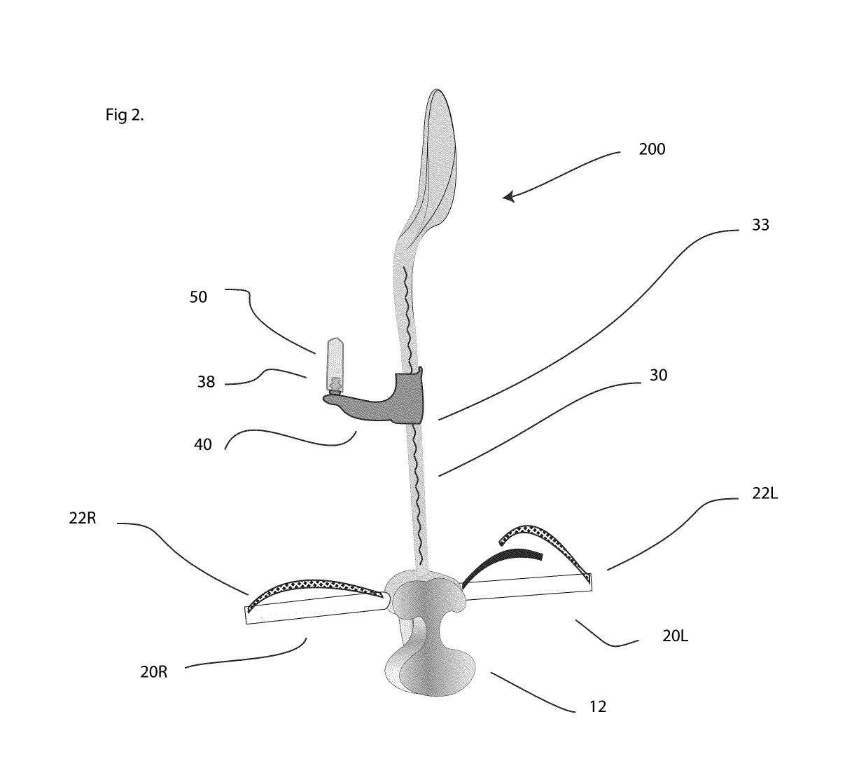

Referencing the drawings, FIG. 1 shows an embodiment of the device 100, when disassembled. FIG. 2 shows the embodiment 100 fully assembled 200. In this embodiment the device would be constructed of PVC, aluminum or some other lightweight polymer. Referring to FIG. 1, and FIG. 1B and FIG. 2, the base unit 12 is a substantially hour glass shaped body. On each side of base unit 12, foot placement section 18 is a configuration of members for engagement by a user's feet, when the user is facing the front of the base unit 12. In this embodiment, foot placement sections 18 are located at the narrowest section of base unit 12 and are designed and positioned onto the right and left side of base unit 12 for a user to place each foot. With the user's feet in this narrow section 18 of base unit 12, the wider sections of base unit 12 allow the feet to push and pull on base unit 12 with the user's plantar, sides and dorsal parts of the feet. On the wide end closest to the front of base 12 are large footrest female threads 16L and 16R. In this embodiment, on its front side, base unit 12 further comprises a lower body receptor 26 which is a locking means to releasably lock an elongated tubular member, which in this embodiment is the lower body socket lock 28A of the lower body 28 shown in FIG. 1. Lower body receptor 26 can be a recess formed within the front of base unit 12 or can be a projection from base unit 12. In this embodiment lower body receptor 26 is a tubular projection defining an inner passage part for lower body socket lock 28A of lower body 28 to mate with base unit 12. Base unit 12 also comprises slide fin 19, which is a substantially hemispherical shaped member on the bottom side of base unit 12. Slide fin 19 is for being able to pivot base unit 12 and for ease of sliding the base unit along a surface.

FIG. 1B shows an enlarged side perspective view of base unit 12 with lower body receptor 26 and button catch hole 26A.

As shown in FIG. 1 large left footrest 20L and large right footrest 20R are a pair of elongated tubular members comprising a proximal and distal end. Each large footrest 20R and 20L comprise large left footrest male thread 24L and large right footrest male thread 24R on each proximal end. Each footrest 20L and 20R is assembled to the base unit 12 by threading large footrest males threads 24L and 24R into footrest for large footrests female thread 16L and 16R located on either side of base 12. The length of the large footrest for the left foot 20L and large footrest for the right foot 20R are each approximately 16″, however, the lengths of large footrests 20L and 20R may vary depending on an individual user's height. In this embodiment large footrests 20L and 20R are substantially elongated tubular members with a diameter of 1 inches to 3 inches.

In FIG. 2 the device is shown with large left footrest 20L and large right footrest 20R after they are threaded into large footrest female thread 16R and 16L, on either side of base unit 12. Large footrest male threads 24L and 24R and their counter parts large footrest female threads 16L and 16R are very large or very course sized male to female thread combination. The primary reason for this design is for easy and quick threading and unthreading of the parts from each other.

As shown in FIGS. 1 and 2, attached to the top of large left footrest 20L and large right footrest 20R, are left foot strap 22L and right foot strap 22R. Foot straps 22L and 22R are made of braided nylon and are approximately 1 inch wide. Foot straps 22L and 22R are secured by use of a hook and loop material such as Velcro and can be adjusted to accommodate the users feet and preferred level of snugness.

In FIG. 1, lower body socket lock 28A is molded as part of lower body 28 and is a button and spring locking mechanism well known in the art. Lower body 28 is mated to lower body receptor 26 on base unit 12 by pushing socket 28A into receptor 26 and allowing the spring and lock button on socket 28A to catch on button catch hole 26A. On the opposite end of lower body 28 is upper body receptor 28B which can be mated to upper body 32 by pushing the end of upper body 32, which comprises upper body socket lock 32A and is the same button and spring locking mechanism as lower body socket lock 28A. Lower body 28 is an elongated tubular member, generally a straight shaft and U shaped cross section. As viewed from the ends, the U shape being approximately 2 inches wide and 2.5 inches tall. The entire length of the lower body 28 is approximately 20 inches. The rounded side of the U shape of lower body 28 is generally smooth and the flat top side of the U shape of lower body 28 has molded ridges 30, along the length that help a user when gripping lower body 28. Additionally, ridges 30 are to prevent support arm 40 from sliding after being set into position.

In FIG. 2 lower body 28 is shown after being mated to base unit 12 and after upper body 32 is mated to lower body 28.

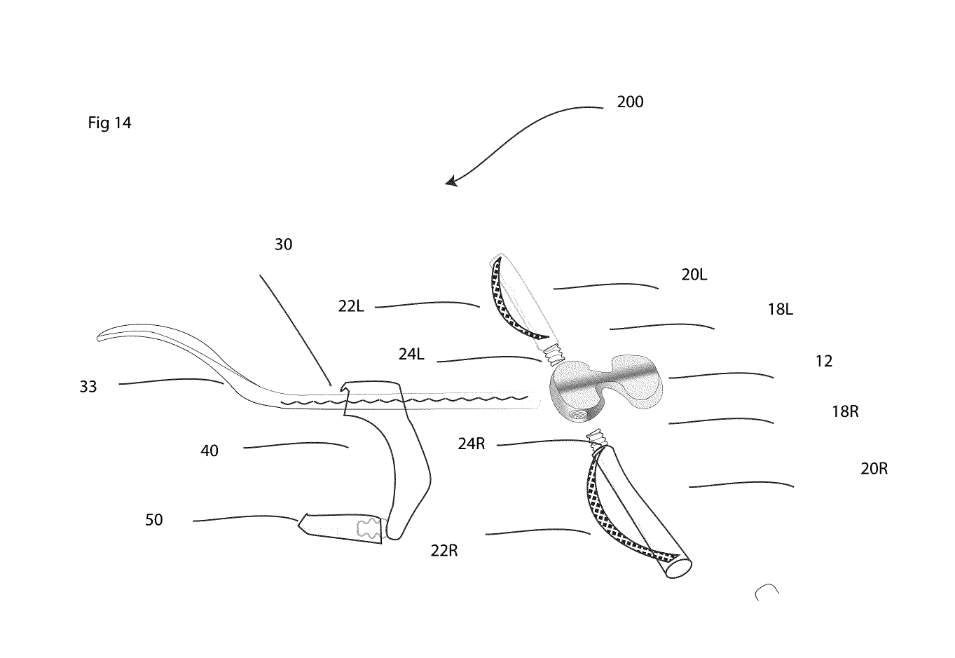

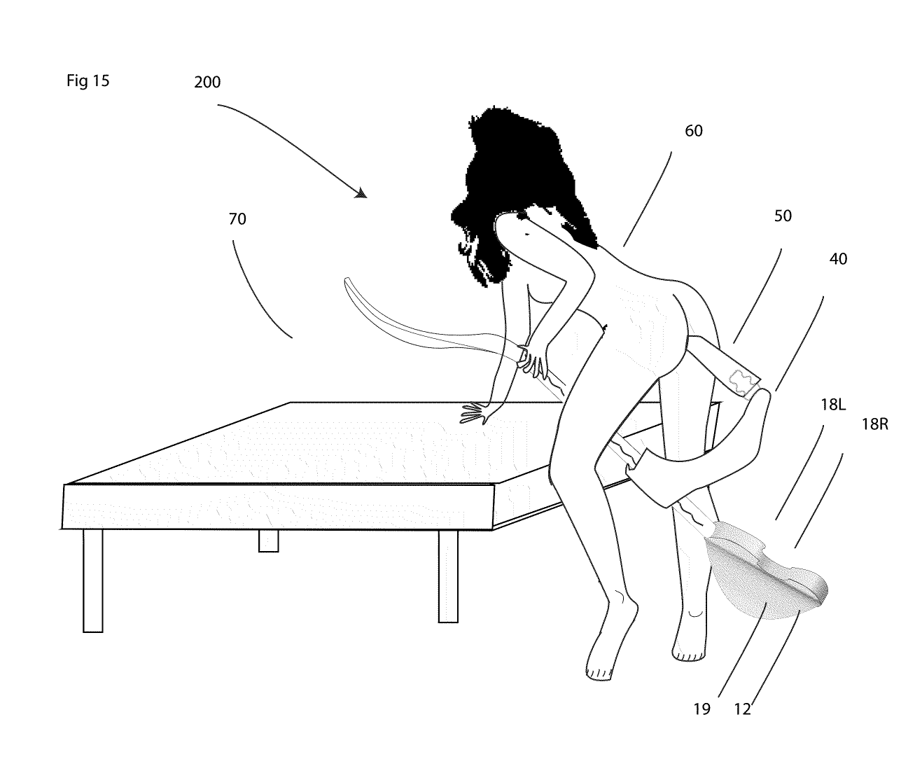

Upper body 32 is approximately the same length as lower body 28. Upper body 32 is the same straight shaft and has the same “U” shape and ridges 30 as lower body 28 for approximately ⅓ of its length and then changes to a flattened shape. After the ⅓ length described, upper body 28 curves upwards at an angle and then straightens again forming a Z shape when looked at length wise from the side, FIG. 14. As shown in FIG. 2, body assembly 33 is lower body 28 and upper body 32 after both pieces are assembled together.

In FIG. 1 support arm 40 is shown unattached to the device.

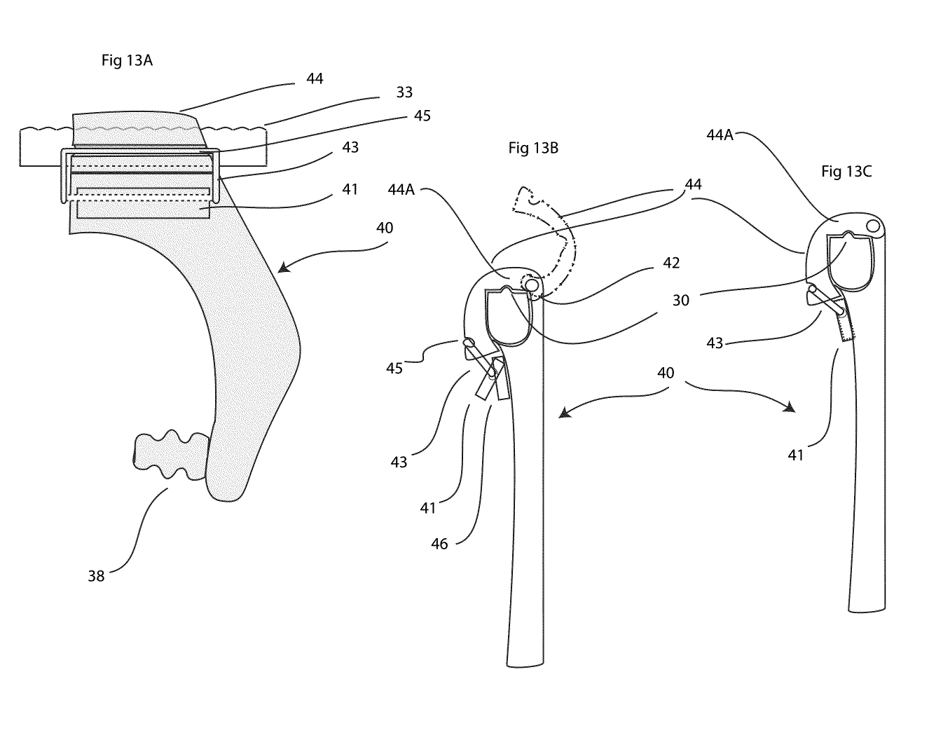

In FIG. 2 support arm 40 is shown attached to the device. FIG. 13A shows a side view of support arm 40 with clamp 44 in the closed and locked position around a section of body assembly 33. Clamp 44 is closed and locked by tightening securing bar 43 into securing groove 45 by pulling down on latch handle 41. FIG. 13A further shows element mount 38 which can be comprised of one of many which are well known in the art. In this embodiment, element mount 38 is a plug and phallic device system.

FIG. 13B shows a cross section rear view of support arm 40 with clamp 44 in both the closed position (solid lines) and the open position (dashed lines) as clamp 44 is able to swing around hinge 42. FIG. 13B shows securing bar 43 placed into securing groove 45 in the closed but unlocked position since latch handle 41 has not been pulled down. To open clamp 44 as shown in FIG. 13B (dashed lines) securing bar 43 is pulled out of securing groove 45. FIG. 13C shows clamp 44 in the locked position with latch handle 41 fully pulled down.

Referring to FIG. 2, when support arm 40 is attached to body assembly 33 of assembled device 200, support arm 40 is held into a secure and immovable position by the section of ridges 30 that is enclosed within the recessed grooves 44A of clamp 44, FIGS. 13A, B and C. The inner wall of clamp 44 that closes around the section of body assembly 33 is formed with recessed grooves 44A of the same shape as ridges 30 on body assembly 33 so as to be spline fit with body assembly 33. When clamp 44 closes, ridges 30 spline fit into the matching recessed grooves 44 on the inside wall of clamp 44 and prevent any movement of the support arm 40 along the upper body 33.

The intention of the present device is for sexual stimulation when in use by a user. Furthermore, simulating having a sexual experience with a partner is another intention of the present device and the following figures describe the manner in which the present embodiment accomplishes this goal. For example, when having sexual intercourse in the missionary position, as when the partner being penetrated by the other is on a flat surface on his or her back, there are various positions that the body takes. The partner on the bottom may have his or her legs spread at varying widths. The feet may be spread wide apart while the knees are held closer together or the knees may also be held wider apart while the feet are held closer together. Also, the knees and feet simultaneously may be spread wider apart or closer together. Another variation is the partner on the bottom having his or her knees bent at an acute angle where the knees are brought as close to the head and chest possible or vice versa where the legs are held out as straight as possible. Yet another position is when the user on the bottom places the plantar surface of his or her feet on the flat surface and lifting his or her buttocks off the flat surface by arching his or her back.

FIG. 3 shows a female user 60 laying on her back on a flat surface 70. The user 60 places her feet onto large left footrest 20L and large right footrest 20R and tightens straps 22L and 22R around the top of each foot respectively. In FIG. 3, support arm 40 is secured close to base unit 12 so that user's 60 knees and thighs are in a more perpendicular position with respect to user's 60 upper torso. In FIG. 3 stimulating element 50 is not inserted into the user's orifice. The user may choose to hold body assembly 33 by use of hands or let body assembly 33 rest against her chest.

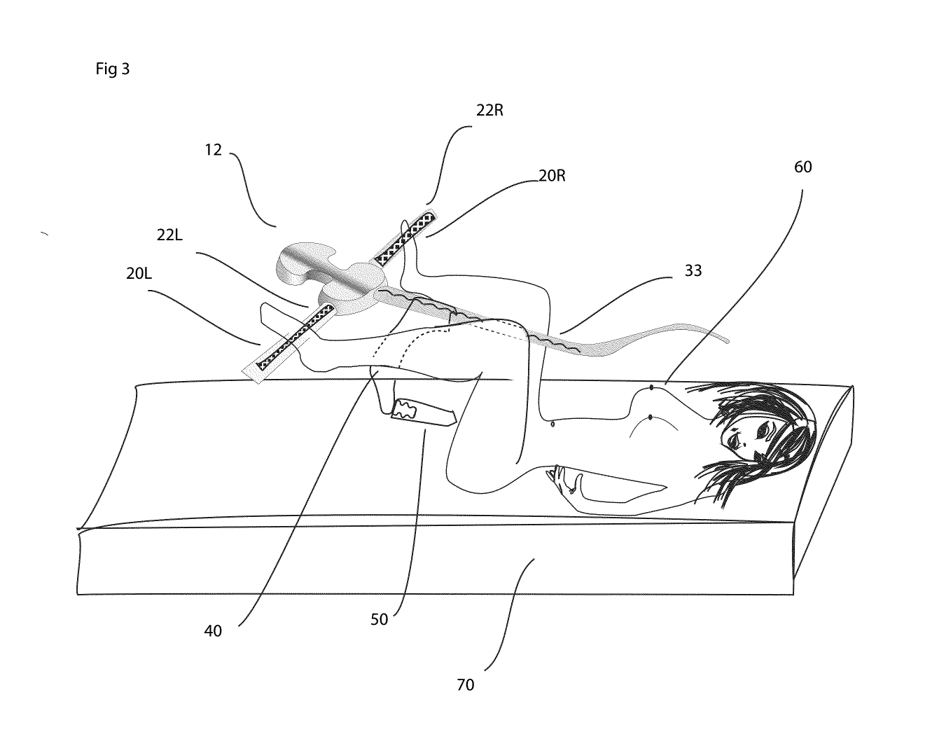

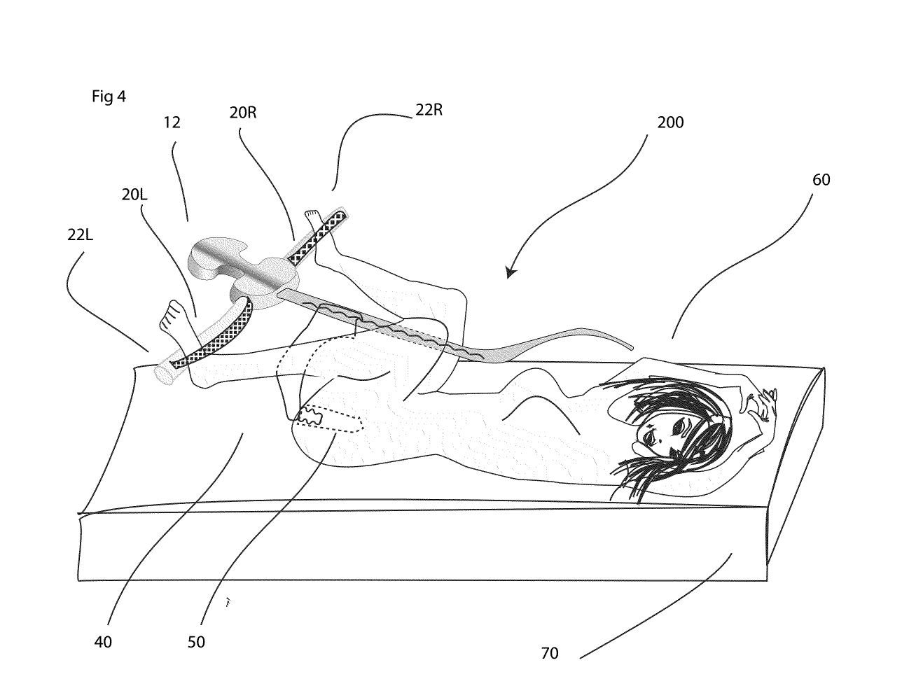

FIGS. 4 and 5 show the user 60 of FIG. 3 after inserting stimulating element 50 into an orifice by pulling back on large footrests 20L and 20R by moving her knees closer to her chest wherein her feet will pull against straps 22L and 22R inserting stimulating element 50. FIG. 4 shows user 60 with her legs in one of the multiple possible positions during use of the device 200 with her legs and ankles spread wide, outwards away from base unit 12. FIG. 5 shows an alternate position that can be achieved if the user 60 slides her feet along straps 20R and 20L, bringing her feet close to the sides of base unit 12. As seen in FIGS. 3-5, a user 60 can manipulate a stimulating element 50 into or out of the user's 60 orifice by use of her feet at the preferred speed and intensity desired. Additionally a user is able to adjust the spread of her feet and legs by sliding her feet along the length of large footrests 20L and 20R without having to stop to make any adjustments. Furthermore, movement of stimulating element 50 can be done by movement of the user's feet alone by pivoting the portion of the leg between the knees and feet whereby the knees stay in a generally fixed position while the feet are moving up and down. Using the hands alone also can do manipulation of the entire device. In this case the user can remove his or her legs from between large footrests 20L and 20R and position the legs as desired while holding upper body 33 with his or her hands.

Manipulation of the device into and out of an orifice can be done with the base unit 12 sliding back and forth or pivoting on slide fin 19 or held so as to not be in contact with the surface.

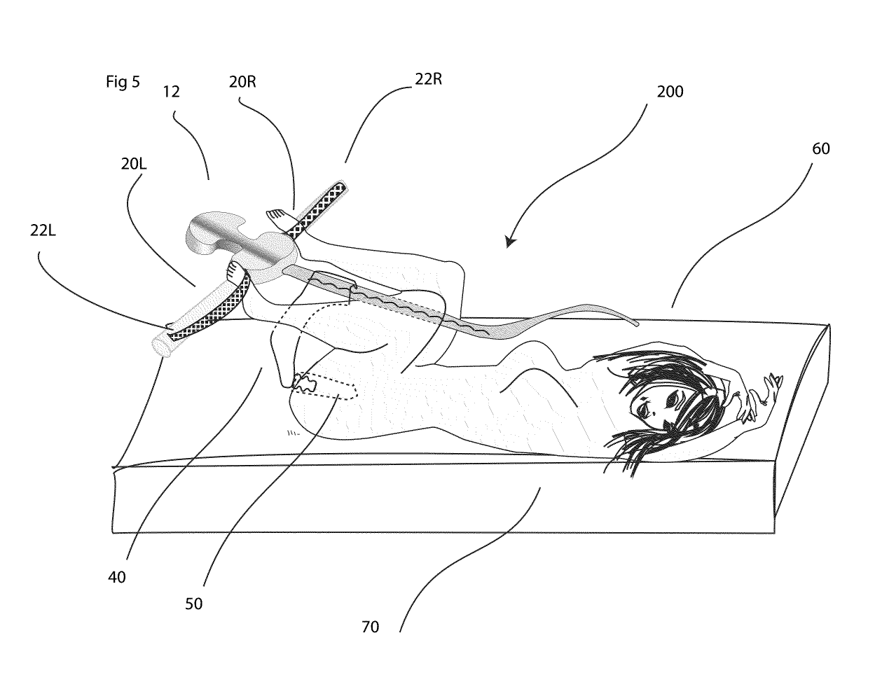

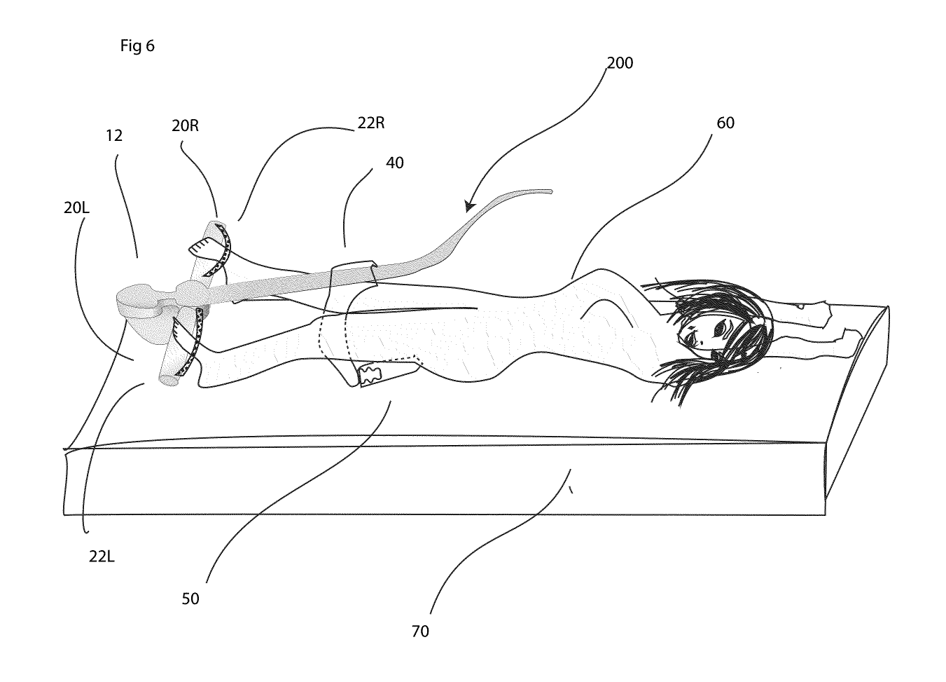

FIGS. 6 and 7 show a female user 60 using device 200 lying on a flat surface 70 with support arm 40 in an alternate position. In FIGS. 6 and 7 support arm 40 is secured farther away from base 12 than shown in FIGS. 3-5 so that user's 60 legs are able to be fully extended at starting position FIG. 6. After insertion of stimulating element 50, FIG. 7, the user's legs are bent at a more obtuse angle than that of FIG. 4 or FIG. 5.

During sexual intercourse between two partners, changing sexual positions is usually a relatively simple matter and is normally able to be done relatively quickly. Accordingly, it is the intention of this device to make changing sexual positions when in use as quickly and easily as if the user were with a real partner. Changing the position of the support arm can be done by the user without having to remove his or her feet from the device or having to stop movement for very long.

Referencing FIG. 13A and 13B the position of support arm 40 can be adjusted quickly during use by lifting latch handle 41, sliding support arm 40 to the desired position and then pushing latch handle 41 to the closed position FIG. 13 C.

As shown in FIGS. 3-7 and FIGS. 13A-C, a plurality of adjustments to enable preferred positioning of user's body, are possible before and during use of the device. Additionally, the light weight of the device facilitates ease of use.

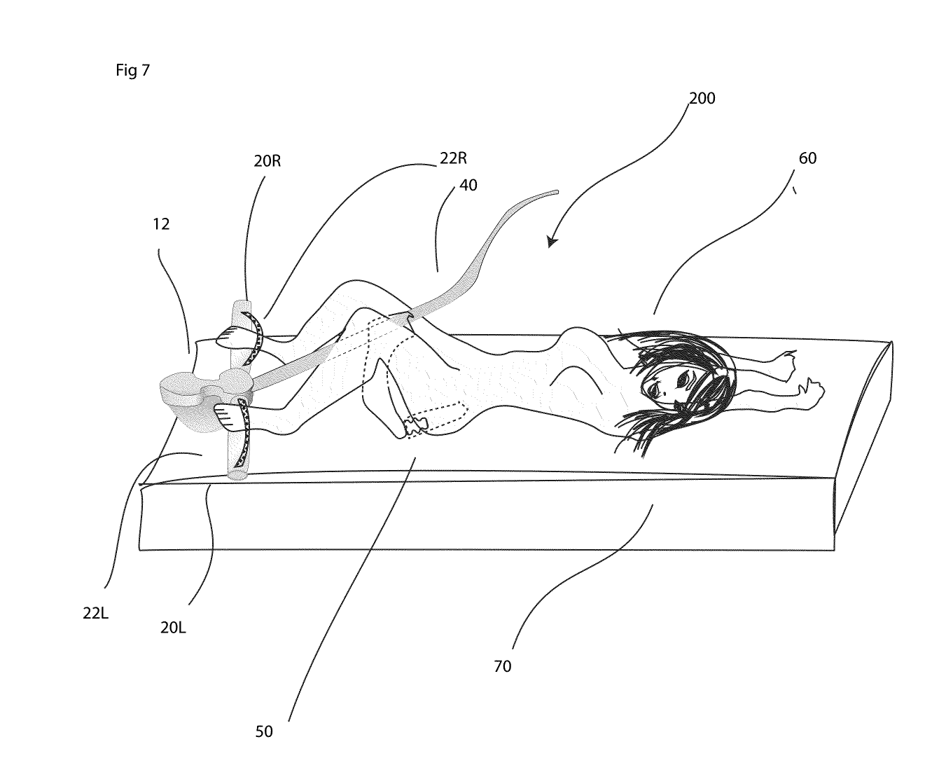

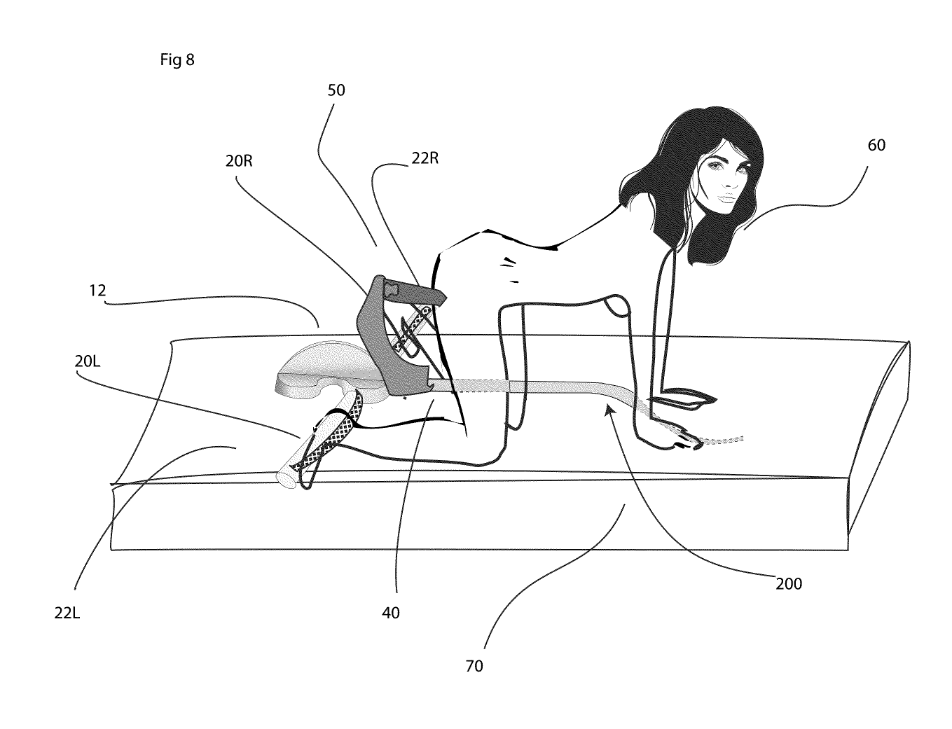

FIGS. 8-9 show an alternate position that can be achieved with the embodiment. FIGS. 8-9 show a female user 60 on a flat surface 70 resting on her hands and knees. If the user is changing from the missionary position FIGS. 3-7, to the hands and knees position, simply turning the device over and laying it on a flat surface is the first step. Then, user 60 gets on her hands and knees with the device between her hands and knees and places her feet in between large footrests 20L and 20R and foot straps 22L and 22R. With the device held in place by the user's feet, stimulating element 50 can be manipulated into an orifice as shown in FIG. 9 and out of an orifice as shown in FIG. 8, by thrusting the user's hips forward and backwards and/or pivoting forwards and backwards on her knees. Additionally, the user can remove her feet from between large footrests 20L and 20R and foot straps 22L and 22R and move the device by use of her hands into and out of an orifice. The user's feet can also be placed into foot placement section 18 of base unit 12 securing the device and thrusting his or her hips and/or pivoting forwards and backwards on her knees. As another use in this position, a user can stand upright on her knees without her hands on the flat surface, hold the body assembly 33 so that the device is at a roughly 30-45 degrees angle and then thrust her hips to move the stimulating element into and out of an orifice.

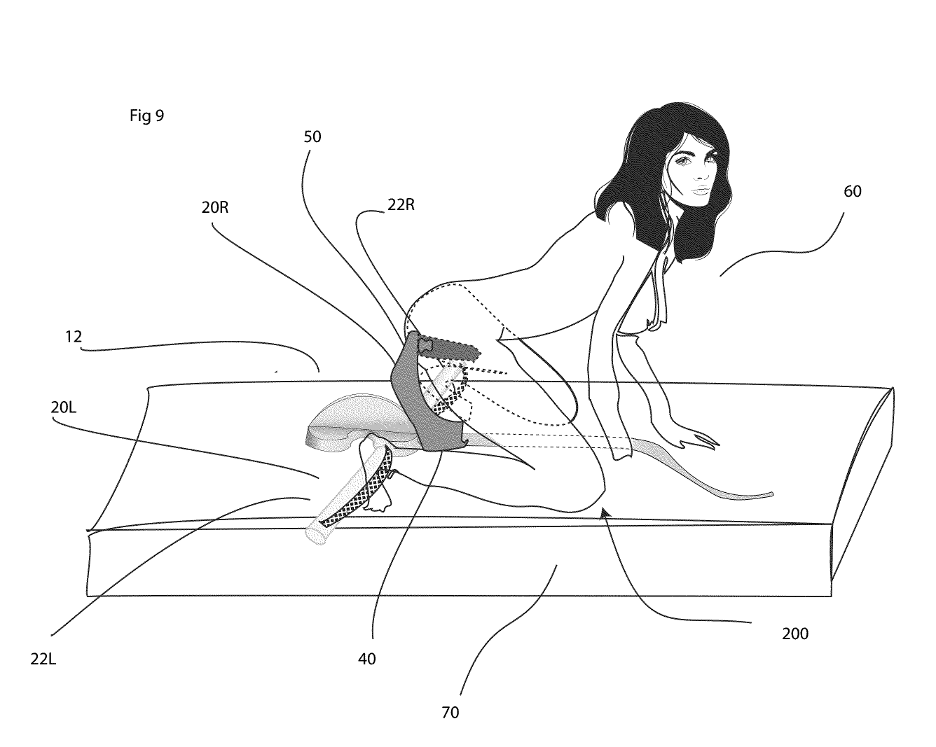

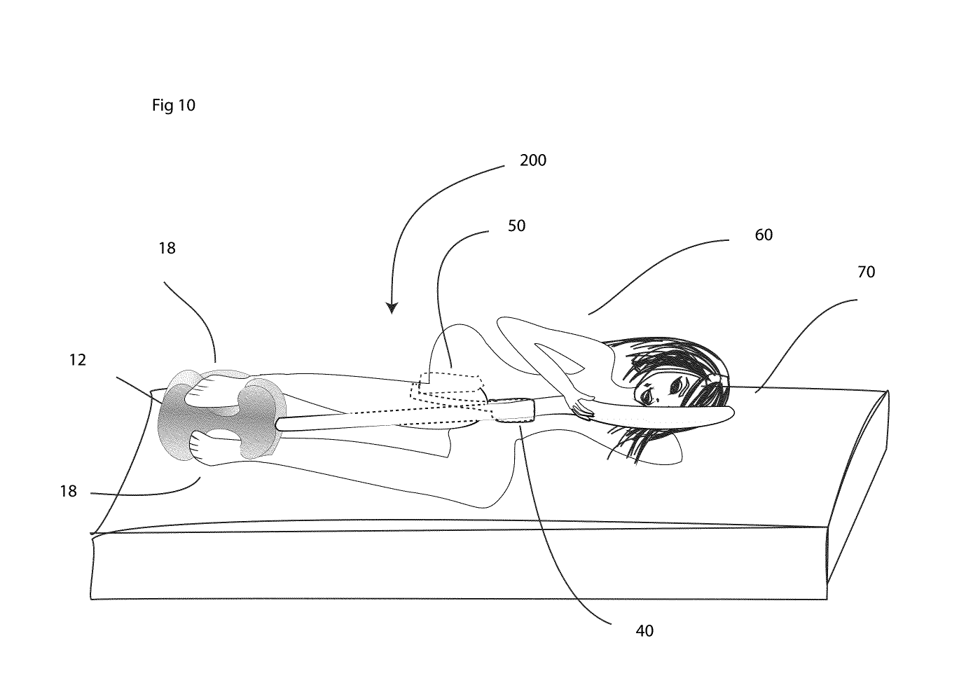

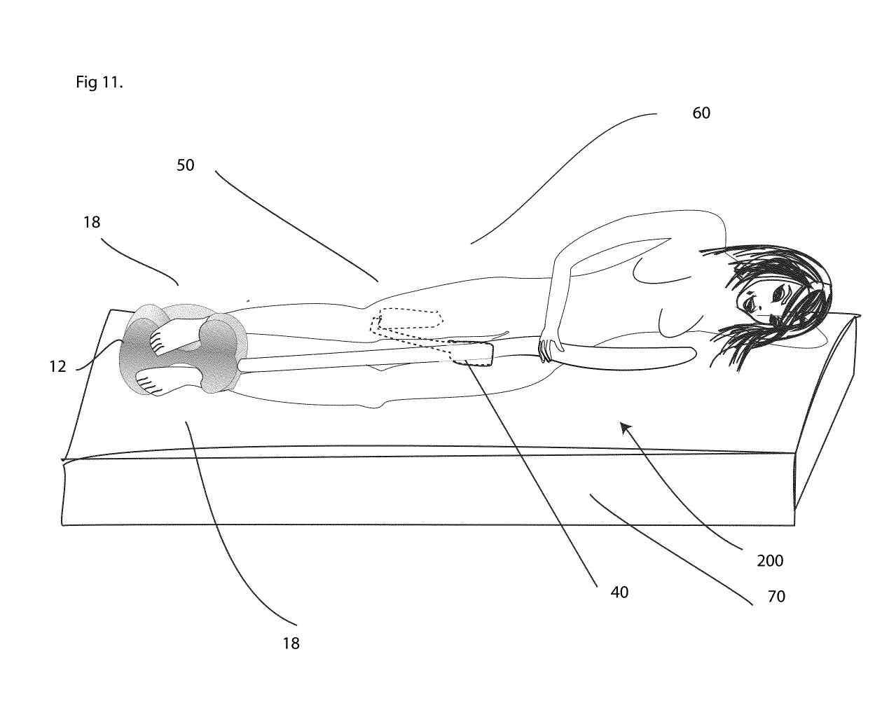

FIGS. 10 and 11 show an alternate use of the device 200. In this form large left footrest 20L and large right footrest 20R are removed from base unit 12. Large footrests 20L and 20R can be unthreaded from base unit 12. Unthreading large footrests 20L and 20R from large footrest female threads 16L and 16R located on the sides of base unit 12 is able to be done quickly since the male and female threads are designed to be as large as possible. Large foot rests 20L and 20R are meant to be threaded into base unit 12 just enough so that footrests 20L and 20R will stay inserted into base unit 12 while the user is moving his or her feet from wider and narrower positions. Also, in this manner, footrests 20L and 20R will maintain some rotational movement while in use so that the user's ankles can extend or contract during use.

Referring to FIG. 11, user 60 is lying on her side with her legs extended. With the device in between the user's legs, the feet can be placed in foot placement sections 18. The user, by moving her knees towards her chest while keeping both feet in the foot placement sections 18, can move stimulating element 50 as desired. FIG. 10 shows user 60 with stimulating element 50 inserted in an orifice. FIG. 11 shows the user 60 with stimulating element 50 removed from an orifice.

The positions described in FIGS. 3-9 can be achieved to a large extent without the large footrests 20L and 20R attached. In another possible embodiment, FIG. 1A, the base unit 12 does not have a means for mating the large footrests 20L and 20R. As described throughout, the position of support arm 40 can also be quickly adjusted along the ridges 30 while the device is being used in this form (without large footrests 20L and 20R) attached to the device.

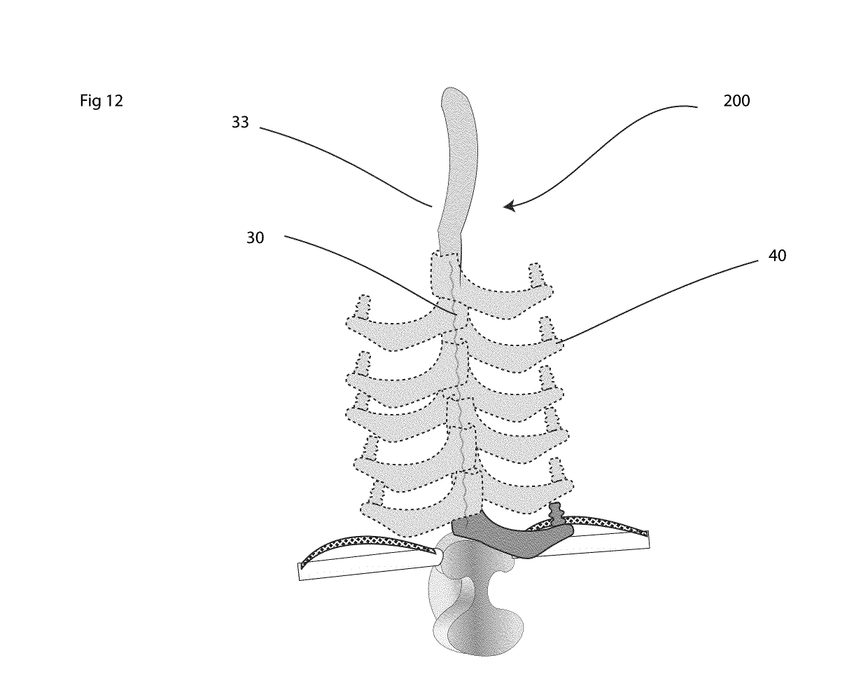

FIG. 12 shows the device 200 with the support arm 40 in a plurality of positions along the length of the body assembly 33.

FIG. 14 shows a perspective drawing of the device from the side view.

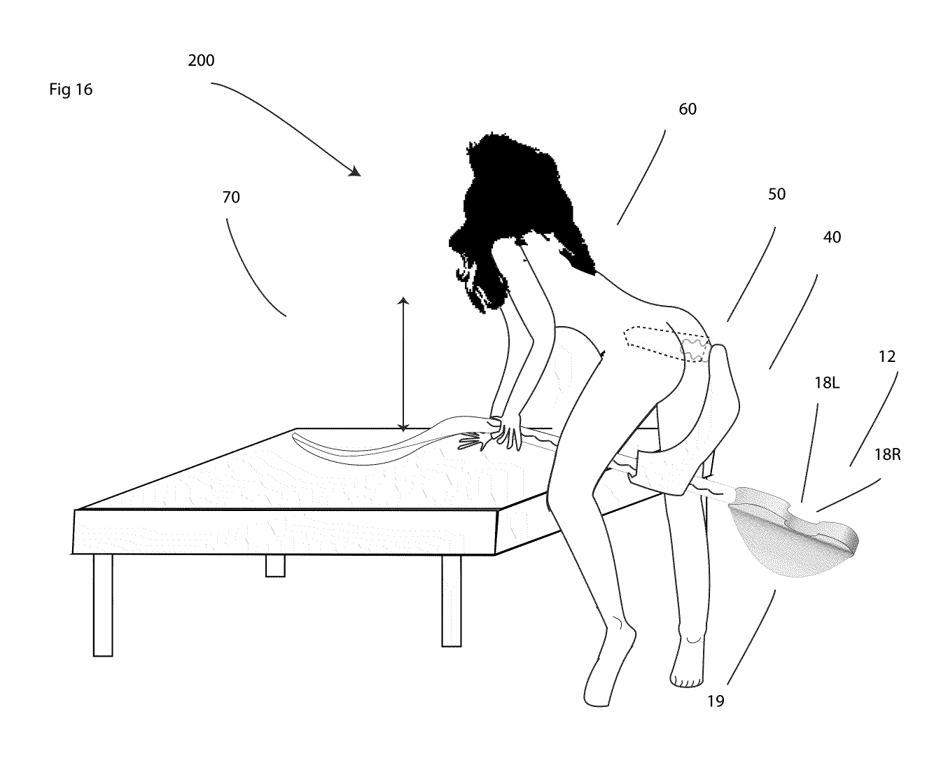

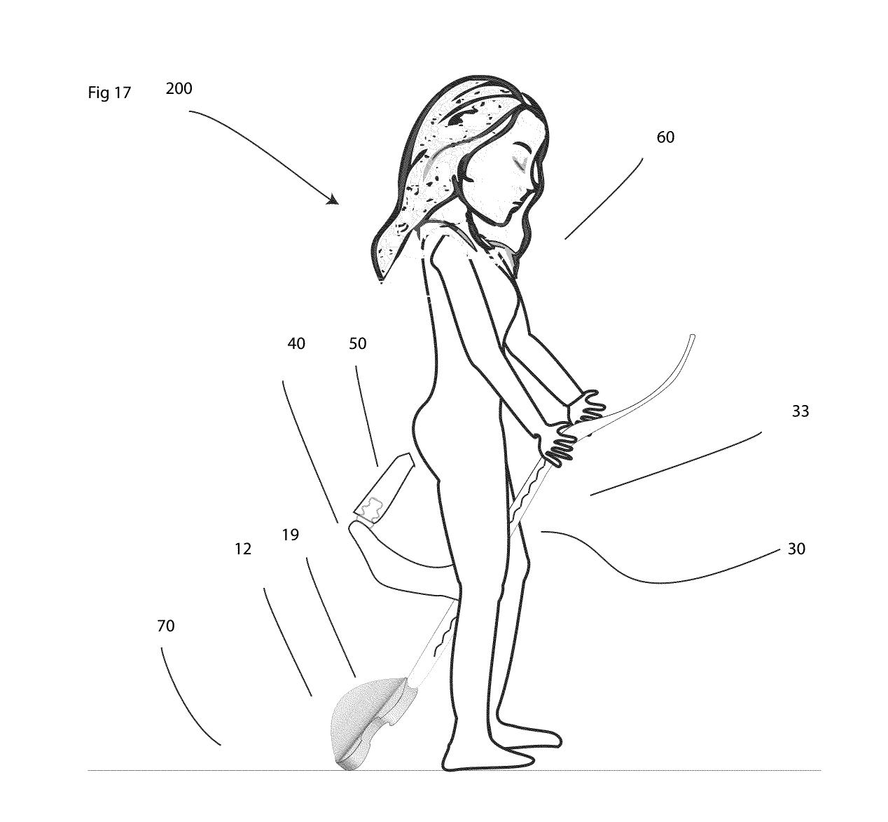

FIGS. 15 and 16 show an alternate use of device 200. In this form the user 60 holds the device and positions the body assembly against the edge of a flat surface and stands with the device between his or her legs with the support arm 40 and stimulation element 50 behind her and positioned near an orifice. By alternately pushing down and pulling up on the body assembly 33, towards and away from the flat surface 70, FIG. 16, the device pivots along the fulcrum created by contact with the corner of the flat surface thereby moving the support arm 40 and stimulating element 50 into and out of an orifice.

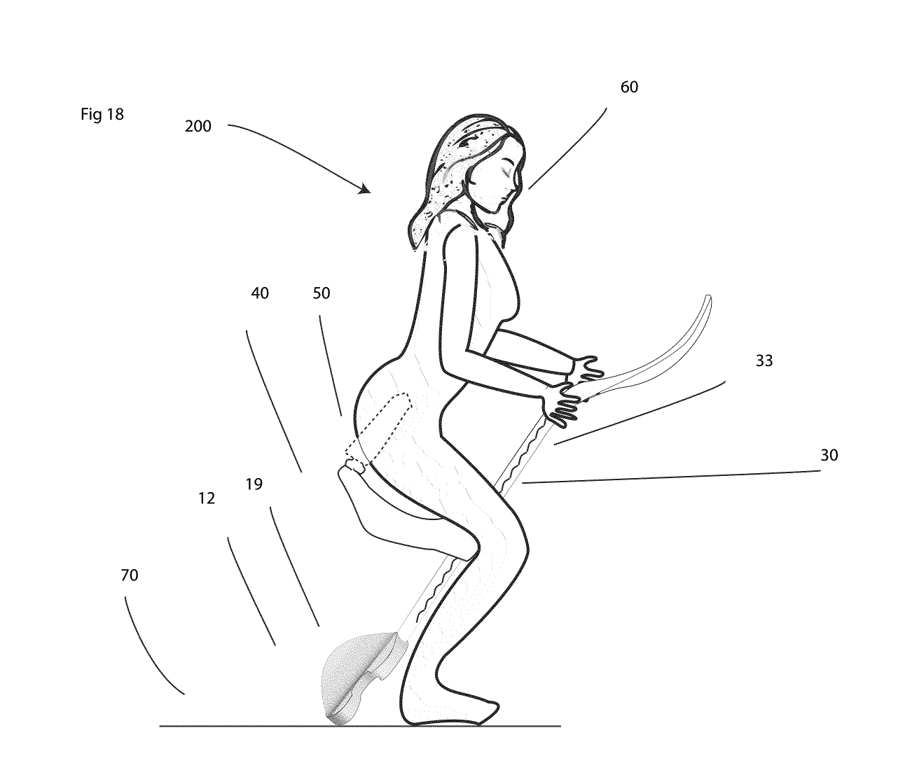

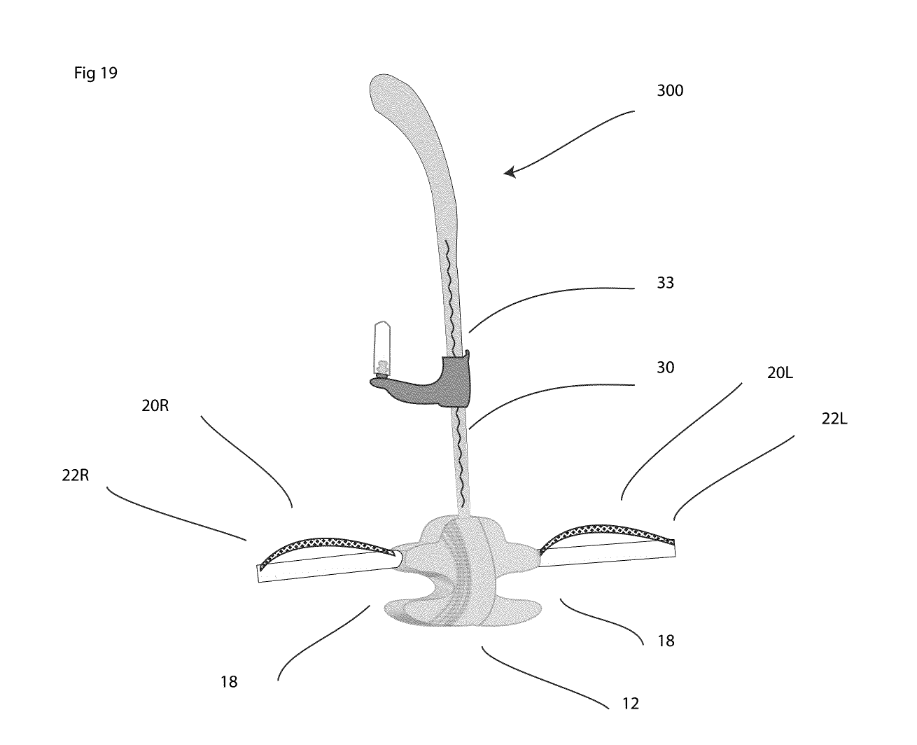

FIGS. 17 and 18 show an alternate use of device 200. In this form the user is in a standing position and holds the device 200 with the support arm and stimulating element positioned towards an orifice. The user 60 by alternately squatting and standing can move the stimulating element into and out of an orifice.

### CONCLUSION, RAMIFICATIONS, AND SCOPE

Although the description above contains many specifics, these should not be construed as limiting the scope of the embodiments but as merely providing illustrations of some of the several embodiments. For example, the base unit 12 can have other shapes, such as oval or round or another shape. Additionally, any of the other individual parts of the device can be of different lengths, widths or shapes.

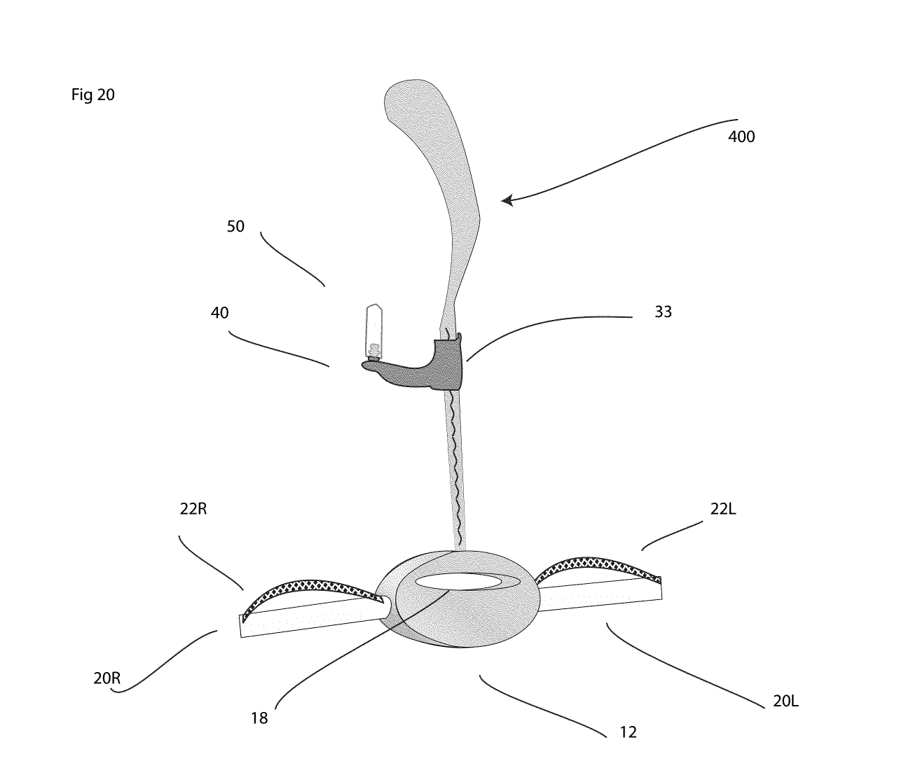

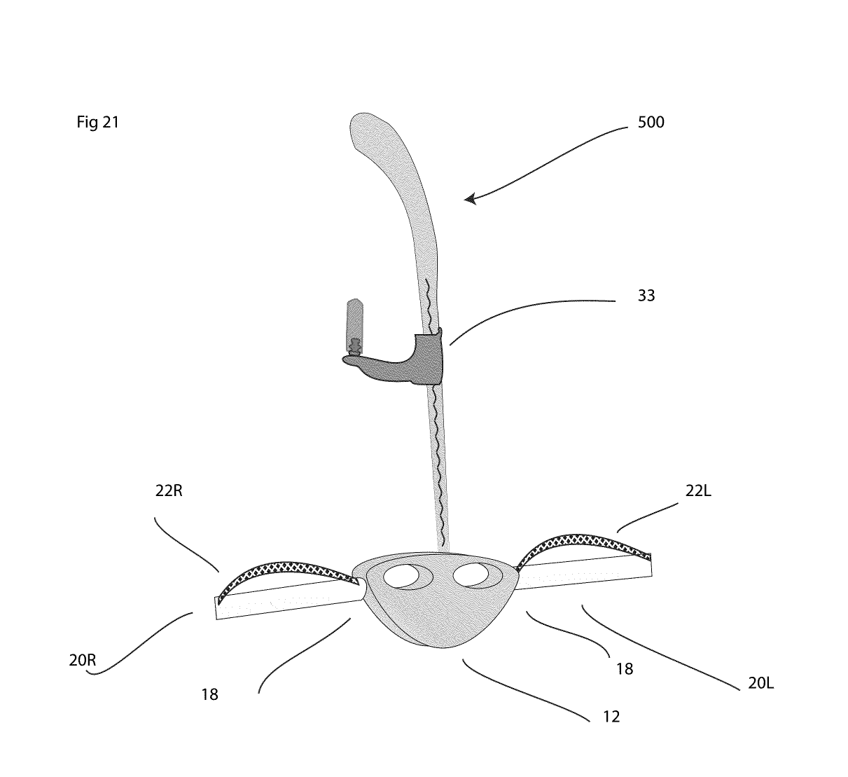

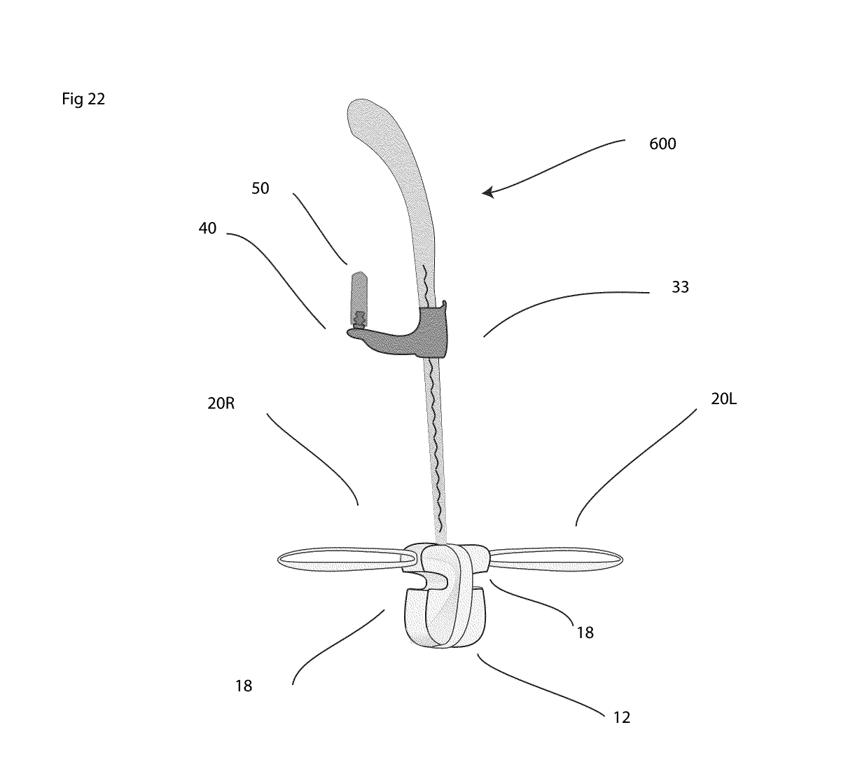

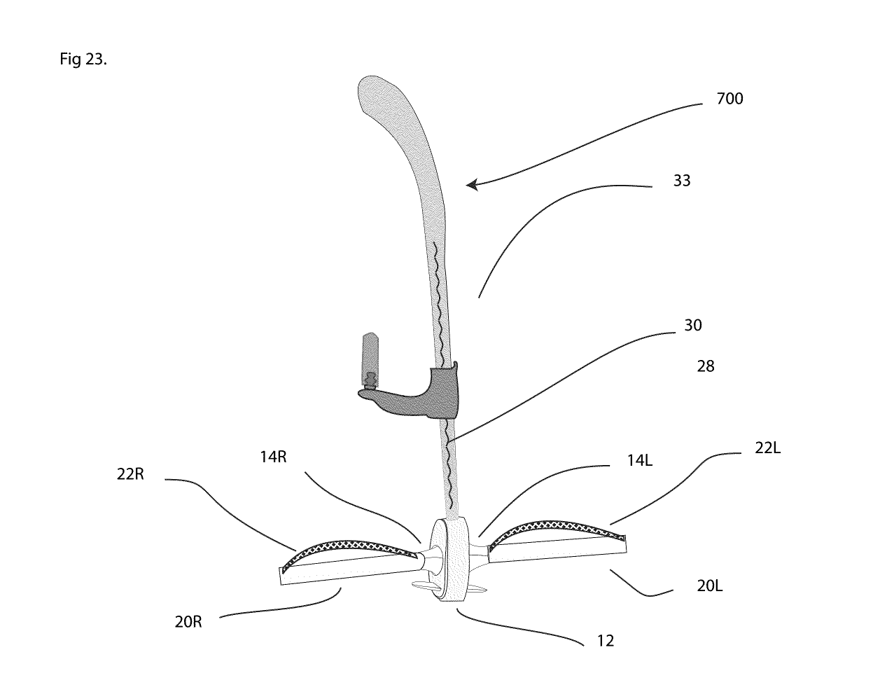

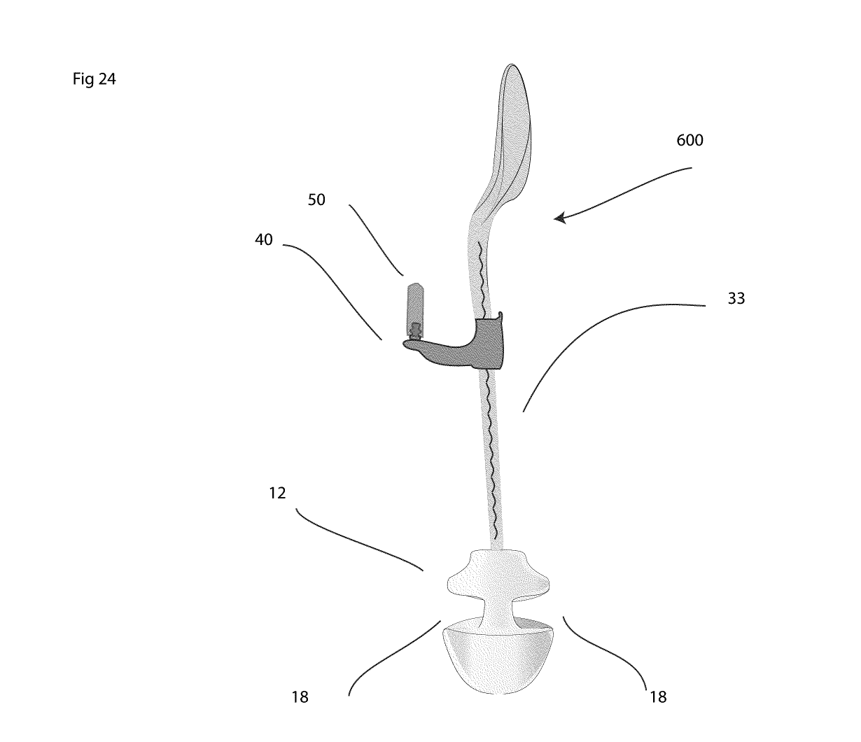

Accordingly, to fulfill the intended advantages of the device and the intended purpose for engagement of the user's feet with base unit 12, reference is made to FIGS. 19-24. As seen in these 6 alternate embodiments, engagement with the base unit by the user with the user's feet is not limited to any particular embodiment. For example, FIG. 19 shows base unit 12 having a generally hour glass shape, however foot placement sections 18 are more deeply narrowed. FIG. 20 shows base unit 12 with a hollow in its center large enough to accommodate both of the user's feet. FIG. 21 shows base unit 12 with 2 hollows in the base unit 12 sized to fit each of the user's feet individually. FIG. 22 shows a base unit 12 with a substantially violin shape. FIG. 23 shows base unit 12 comprising a substantially “U” shaped and disk like body with truncated cone shaped projections on the right and left sides and platforms adjacent to the truncated cone shaped projections for the user's feet. The space between the projections and the platforms comprising the foot placement sections 18 and the outer exposed base of the truncated cone shaped projections comprising female threaded holes for the large footrests 20L and 20R. FIG. 24 shows base unit 12 as a more actual hour glass shape whereby foot placement section 18 can be anywhere along the circumference of the circular shape of base unit 12.

Additionally, the base unit 12 need not comprise large footrests female threads 16L and 16R. FIG. 1A shows an embodiment without female threads for large footrests 16L and 16R.

Referencing another embodiment, FIG. 22, large footrests 20R and 20L and left and right foot straps 22L and 22R, are configured as a single member. As shown, large footrests and foot straps 20R and 20L and 22R and 22L are each comprised as an oval shaped single unit designed with the strapping mechanism integrated so a user can place each foot into the opening of each unit on each side.

An example of another embodiment of the device is a base unit comprising of formations roughly in the shape of bicycle pedals on each flat side; as another example, the large footrests 20L and 20R can be longer or shorter, have a flat shape rather than round, can be ridged along the length for foot grip or comfort, can have another means for quick attachment to the base 12; the shape of the support arm 40 and means for quick release and attachment to the body assembly 33 can be modified. The means of attachment of a stimulating element 50 to the support arm 40 can be changed to others which are well known in the art. The means of attachment of the various detachable parts of the invention can be modified, for example, instead of one part being threaded into the other, an alternate means of push lock attachment can be used; alternately, the detachable parts can be made as one piece even though the idea of the invention being compact enough to be stored in a smaller space has been described in this embodiment.

Because many varying and different embodiments may be made within the scope of the inventive concept herein taught, and because many modifications may be made in the embodiments herein detailed in accordance with the descriptive requirement of the law, it is to be understood that the details herein are to be interpreted as illustrative and not in any limiting sense. Thus, the scope of the embodiments should be determined by the appended claims and their legal equivalents, rather than by the examples given.

I claim:

1. A sex toy for simulating sexual encounters by a user comprising:
a) a base unit of predetermined shape and size comprising a configuration of members for engagement of said user's feet, said configuration of members being disposed in a plane parallel to the front of said base unit and along an axis within said plane
b) an elongated tubular member of predetermined length having proximal and distal ends, the proximal end of said elongated tubular member being mated to said front side of said base unit, said elongated tubular member being disposed generally perpendicularly to the front of said base unit
c) a support arm attached to said elongated tubular member, said support arm comprising a securing mechanism at a location spaced from point of attachment with said elongated tubular member and means to mount a stimulating element onto said securing mechanism
whereby said user may mount said stimulating element for use of the device

2. the device of claim 1 wherein said base unit comprises a female threaded recess on its right and left sides for mating of additional members

3. the device of claim 1 wherein said base unit comprises a recess on the front side of said base unit able to receive a push lock mechanism for mating to an additional member

4. the device of claim 1 further comprising a pair of elongated tubular members, each of said pair of elongated tubular members comprising proximal and distal ends, said proximal ends comprising male threading and means to be mated perpendicularly to said right and left sides of said base unit,

5. the device in claim 4 wherein each said elongated tubular member of said pair of elongated tubular members further comprises adjustable straps along the majority of the length of one of its elongated sides and means for securing said user's feet to said pair of elongated tubular members

6. the device of claim 1 wherein said elongated tubular member mated to front of said base unit is an assemblage of at least 2 parts, said parts comprising button and spring push lock mechanisms and means to be mated to one another and to form a single unit and further means to be mated to said base unit

7. the device in claim 1 wherein said elongated tubular member mated to front of said base unit further comprises ridges along the length of the top side of said elongated tubular member

8. the device in claim 1 wherein said elongated tubular member mated to front of said base unit comprises a predetermined cross sectional shape

9. the device of claim 1 and claim 7 wherein said support arm comprises a hinged clamping mechanism and means for quick relocation of said support arm to a plurality of locations of attachment along said elongated tubular member while in use by said user, said hinged clamping mechanism comprising recessed grooves matching ridges of said elongated tubular member and means to be spline fitted to said elongated tubular member, further, said hinged clamping mechanism when in the closed position being shaped identically to the cross sectional shape of said elongated tubular member so as to be immovably interlocked

10. A sex toy for simulating sexual encounters by a user able to be used in a plurality of positions comprising:
a) a base unit of predetermined shape and size comprising a configuration of members for engagement of said user's feet, said configuration of members being disposed in a plane parallel to the front of said base unit and along an axis within said plane
b) an elongated tubular member of predetermined length comprising proximal and distal ends, the proximal end of said elongated tubular member being mated to the front side of said base unit, said elongated tubular member being disposed generally perpendicularly to the front of said base unit.
c) a pair of elongated tubular members each comprising proximal and distal ends, each proximal end of said pair of elongated tubular members being mated perpendicularly to the right and left sides of said base unit
d) a support arm attached to said elongated tubular assembly, said support arm comprising a securing mechanism at a location spaced from point of attachment with said elongated tubular member and means to mount a stimulating element onto said securing mechanism
whereby said user may mount said stimulating element for use with the device

11. the device of claim 10 wherein said base unit is substantially hour glass shaped, wherein the narrowest portion of said hour glass shape provides means for engagement of said user's feet, said base unit further comprising female threaded recesses on the right and left sides for mating to said pair of elongated tubular members, said base unit further comprising a recess on its front side and means for mating to said elongated tubular member by a push lock mechanism

12. the device of claim 10 wherein each member of said pair of elongated tubular members includes a strap and means for securing said user's feet to the long side of each said elongated tubular member whereby each of said user's feet is prevented from movement away from the surface of said elongated tubular member and unrestrained in movement along the length of said elongated tubular member

13. the device of claim 10 wherein said elongated tubular member is comprised of at least 2 smaller sections with each individual said smaller section of said elongated tubular member having a button and spring push locking mechanism for assembling to each other and to said base unit and disassembled for convenient storage

14. the device of claim 10 wherein said elongated tubular member has ridges along the length of the top of said elongated tubular member

15. the device of claim 10 wherein said elongated tubular member has a predetermined cross sectional shape

16. the device of claim 10 wherein said support arm comprises a hinged clamping mechanism and means for quick relocation of said support arm to a plurality of locations of attachment along said elongated tubular member while in use by said user

17. the device of claim 10 and claim 14 wherein said hinged clamping mechanism for said support arm comprises recessed grooves on the inner wall of its closing arm so that said hinged clamping mechanism of said support arm can be spline fitted with said elongated tubular member mated to front of said base unit and means to prevent slipping of said support arm along length of said elongated tubular member

18. the device of claim 10 wherein said hinged clamping mechanism of said support arm is of the same cross sectional shape as said elongated tubular member so that both are immovably interlocked to one another when said hinged clamping mechanism is in the closed position.
